(19) United States
(12) Patent Application Publication
(10) Pub. No.: US 2013/0076741 A1
(43) Pub. Date: Mar. 28, 2013

(54) THREE-DIMENSIONAL IMAGE DISPLAY APPARATUS

(71) Applicant: Makoto Eguchi, Osaka-shi (JP)

(72) Inventor: Makoto Eguchi, Osaka-shi (JP)

(21) Appl. No.: 13/700,474

(22) PCT Filed: Apr. 12, 2011
(86) PCT No.: PCT/JP2011/002165

§ 371 Date: Nov. 28, 2012

(30) Foreign Application Priority Data
Jun. 11, 2010 (JP) 2010-1335122010

(51) Int. Cl. G06T 15/00

(52) U.S. Cl. CPC G06T 15/00
USPC 345/419

(57) ABSTRACT

A light path control element capable of electrically controlling the path of light output from a backlight source is provided. During display of a left-eye image, a light path allowing the left-eye image (L) to reach the left eye is formed by adjusting the voltage applied to the light path control element. In synchronization with switching of the display image from the left-eye image (L) to a right-eye image (R), the control of the voltage applied to the light path control element is switched to form a light path allowing the right-eye image (R) to reach the right eye.

### TECHNICAL FIELD

The present disclosure relates to a three-dimensional (stereoscopic) image display apparatus that performs three-dimensional image display without use of glasses by a time-sharing system.

### BACKGROUND ART

Various types of methods have been conventionally proposed for displaying three-dimensional images without use of glasses. For example, a parallax barrier method and a lenticular lens method are widely known, which are methods of performing three-dimensional image display by showing different images to the right and left eyes using a parallax barrier and a lenticular lens, respectively. These methods, using a space division system, are inferior in resolution and display quality to ones using a time-sharing system.

Patent Document 1 discloses a three-dimensional image display apparatus including: a display panel that performs spatial modulation with an input video signal to form an image; a polarization conversion element that converts the polarization direction of an incident beam with a voltage applied in synchronization with the video signal; and a switching barrier unit that has first polarization portions having the first polarization direction and second polarization portions having the second polarization direction arranged alternately and allows the beam having passed through the polarization conversion element to pass through at least one of the first and second polarization portions. In Patent Document 1, a video signal in one frame is constituted by a first field video signal and a second field video signal. A first field image is split into a left-eye image and a right-eye image in the first polarization portions, and a second field image is split into a left-eye image and a right-eye image in the second polarization portions. Such field images are sequentially output at high speed, whereby a three-dimensional image can be achieved without degradation in resolution, according to the description in Patent Document 1.

### CITATION LIST

### Patent Document

PATENT DOCUMENT 1: Japanese Patent Publication No. P2007-004179

### SUMMARY OF THE INVENTION

### Technical Problem

The three-dimensional image display apparatus of Patent Document 1 however has the following problem: since the first polarization portions and the second polarization portions are provided in the switching barrier unit, and light must pass through the corresponding polarization portions, the brightness decreases during the passing of the light through the polarization portions, degrading the display quality.

It is an objective of the present disclosure to suppress or reduce degradation in the resolution and display quality of a three-dimensional image display apparatus performing three-dimensional image display without use of glasses.

### Solution to the Problem

The three-dimensional image display apparatus of the present disclosure includes: a backlight unit including a backlight source; and a liquid crystal panel provided on a display side of the backlight unit, configured to transmit light output from the backlight unit, the apparatus performing three-dimensional image display by displaying left-eye images and right-eye images alternately to show the images to the left eye and right eye of the user, respectively, wherein a light path control element capable of electrically controlling the path of light output from the backlight source is provided, during display of a left-eye image, a light path allowing the left-eye image to reach the left eye is formed by adjusting a voltage applied to the light path control element, and in synchronization with switching of the display image from the left-eye image to a right-eye image, the control of the voltage applied to the light path control element is switched to form a light path allowing the right-eye image to reach the right eye.

According to the configuration described above, the light path control element capable of electrically controlling the path of light output from the backlight source is provided. During display of a left-eye image, a light path allowing the left-eye image to reach the left eye is formed by adjusting the voltage applied to the light path control element. In synchronization with switching of the display image from the left-eye image to a right-eye image, the control of the voltage applied to the light path control element is switched to form a light path allowing the right-eye image to reach the right eye. Therefore, three-dimensional display can be performed without degrading the resolution and the display quality compared with those at the time of two-dimensional display.

In the three-dimensional image display apparatus of the present disclosure, the light path control element may be formed of a switching device where a voltage is applied in a direction orthogonal to a direction toward the liquid crystal panel from the backlight unit.

In the above case, the light path control element is formed of a ferroelectric crystal layer including ferroelectric crystals, for example.

According to the configuration described above, in which the ferroelectric crystal layer is provided as the switching device, voltage-applied ferroelectric crystals take on birefringence due to the Pockets effect, causing a change of the light path. Therefore, the direction of the path of light having entered the ferroelectric crystal layer can be controlled arbitrarily.

In the three-dimensional image display apparatus of the present disclosure, the light path control element may be formed of a switching device where a voltage is applied in a direction parallel to a direction toward the liquid crystal panel from the backlight unit.

In the above case, preferably, the light path control element is formed of a nematic liquid crystal layer including nematic liquid crystal.

According to the configuration described above, in which the nematic liquid crystal layer is provided as the switching device, the light path changes due to the anisotropy of the liquid crystal with application of a voltage to the liquid crystal. Thus, the direction of the path of light having entered the switching device can be controlled arbitrarily.

When the light path control element is a switching device to which a voltage is applied in a direction parallel to the direction toward the liquid crystal panel from the backlight unit, the light path control element is formed of a nematic liquid crystal layer including nematic liquid crystal, for example.

In the three-dimensional image display apparatus of the present disclosure, the backlight unit may include a plurality of optical sheets provided on the side of the backlight source closer to the liquid crystal panel, and one of the plurality of optical sheets may be the light path control element.

In the three-dimensional image display apparatus of the present disclosure, the light path control element may be provided between the backlight unit and the liquid crystal panel.

In the three-dimensional image display apparatus of the present disclosure, the light path control element may be provided on the display side of the liquid crystal panel.

In the three-dimensional image display apparatus of the present disclosure, the backlight source may be of an edge light type including a light guide plate and a light source provided at an end of the light guide plate, and the light guide plate may be constituted by a light guide plate body and the light path control element placed on the surface of the light guide plate body facing the liquid crystal panel.

In the three-dimensional image display apparatus of the present disclosure, the backlight source may be of an edge light type including a light guide plate and a light source provided at an end of the light guide plate, and the light guide plate may be constituted by the light path control element.

### Advantages of the Invention

According to the present disclosure, in which the light path control element capable of electrically controlling the path of light output from the backlight source is provided, the light path can be formed to allow the left-eye image to reach the left eye and the right-eye image to reach the right eye by the time-sharing system. Therefore, degradation in resolution and display quality during three-dimensional image display is suppressed or reduced.

### BRIEF DESCRIPTION OF THE DRAWINGS

FIG. 1 is a schematic view of a three-dimensional image display apparatus of the first embodiment.

FIG. 2 is a cross-sectional view of a light path control element in the first embodiment.

FIG. 3 is an explanatory view illustrating the order of images displayed by a liquid crystal panel.

FIG. 4(a) is an explanatory view illustrating a light path at the time of display of a left-eye image in the three-dimensional image display apparatus of the first embodiment, and FIG. 4(b) is an explanatory view illustrating a light path at the time of display of a right-eye image in the three-dimensional image display apparatus of the first embodiment.

FIG. 5 is a schematic view of a three-dimensional image display apparatus of Alteration 1 of the first embodiment.

FIG. 6 is a schematic view of a three-dimensional image display apparatus of Alteration 2 of the first embodiment.

FIG. 7 is a schematic view of a three-dimensional image display apparatus of alteration 3 of the first embodiment.

FIG. 8 is a schematic view of a three-dimensional image display apparatus of Alteration 4 of the first embodiment.

FIG. 9 is a schematic view of a three-dimensional image display apparatus of the second embodiment.

FIG. 10 is a cross-sectional view of a light path control element in the second embodiment.

FIG. 11(a) is an explanatory view illustrating a light path at the time of display of a left-eye image in the three-dimensional image display apparatus of the second embodiment, and

FIG. 4(b) is an explanatory view illustrating a light path at the time of display of a right-eye image in the three-dimensional image display apparatus of the second embodiment.

### DESCRIPTION OF EMBODIMENTS

Embodiments of the present disclosure will be described hereinafter in detail with reference to the accompanying drawings. Note that the present disclosure is not limited to the embodiments to follow.

### First Embodiment

### (Three-Dimensional Image Display Apparatus)

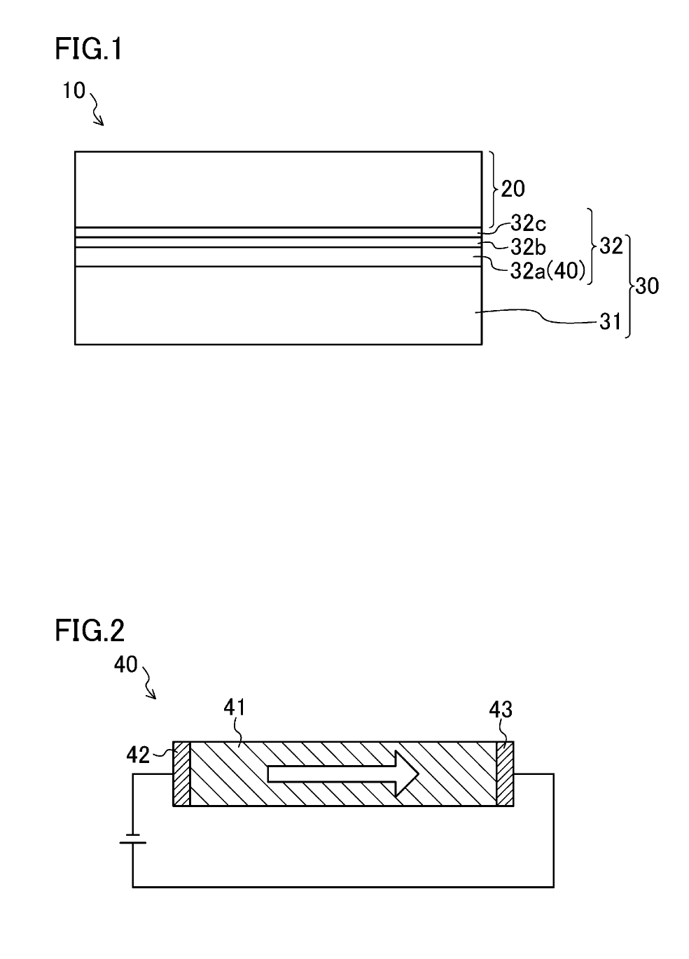

FIG. 1 shows a three-dimensional image display apparatus 10 of the first embodiment. The three-dimensional image display apparatus 10, which permits the user to recognize three-dimensional image display without use of dedicated special glasses, is used for displays of cellular phones, personal computers, TV sets, etc.

The three-dimensional image display apparatus 10 includes a liquid crystal panel 20 and a backlight unit 30 provided on the side of the liquid crystal panel 20 opposite to the display side thereof.

The liquid crystal panel 20 has a known configuration where a TFT array substrate having a TFT provided for each pixel and a color-filter counter substrate having a color filter provided for each pixel are placed to face each other, and a liquid crystal layer is formed between the substrates. Note that, as the TFTs of the liquid crystal panel 20, it is preferred to use TFTs that can be driven at high speed because the liquid crystal panel 20 displays left-eye images L and right-eye images R alternately by switching the display from one to the other.

The backlight unit 30 is of an edge light type including a backlight source 31 having a light guide plate of a known configuration with an LED light source provided at an end. A plurality of optical sheets 32 are provided on the surface of the backlight source 31 on the display side, and a reflection sheet (not shown) is provided on the surface thereof opposite to the display side. Note that the backlight unit 30 may be of, not the edge light type described herein, but a direct type, or a type of using an organic EL body as the backlight source 31.

The plurality of optical sheets 32 have a laminated structure of a light path control element 40 (32a), a diffusion sheet 32b, and a prism sheet 32c. Note that it is necessary to include at least the light path control element 40 (32a) in the plurality of optical sheets 32, and that an optical sheet other than the diffusion sheet 32b and the prism sheet 32c may be included. Also, although FIG. 1 illustrates lamination of the light path control element 32a, the diffusion sheet 32b, and the prism sheet 32c in this order, the order of lamination is not limited to this, but may be changed arbitrarily.

As shown in FIG. 2, the light path control element 40 includes a ferroelectric crystal layer 41 with a pair of electrodes 42 and 43 provided at both ends. As ferroelectric crystals constituting the ferroelectric crystal layer 41, use of lithium niobate (LiNbO3) and potassium tantalate niobate (KTa1-xNbxO3) that are large in electrooptical constant is preferred. The ferroelectric crystal layer 41 has a thickness of 50 to 100 μm, for example. In the ferroelectric crystal layer 41, with the pair of electrodes 42 and 43 provided at both ends, a voltage can be applied in a direction (direction of the arrow in FIG. 2) orthogonal to the direction toward the liquid crystal panel 20 from the backlight unit 30.

The pair of electrodes 42 and 43 can be bonded to the ends of the ferroelectric crystal layer 41 with a conductive epoxy resin, etc.

As the diffusion sheet 32b and the prism sheet 32c, conventionally known configurations can be used.

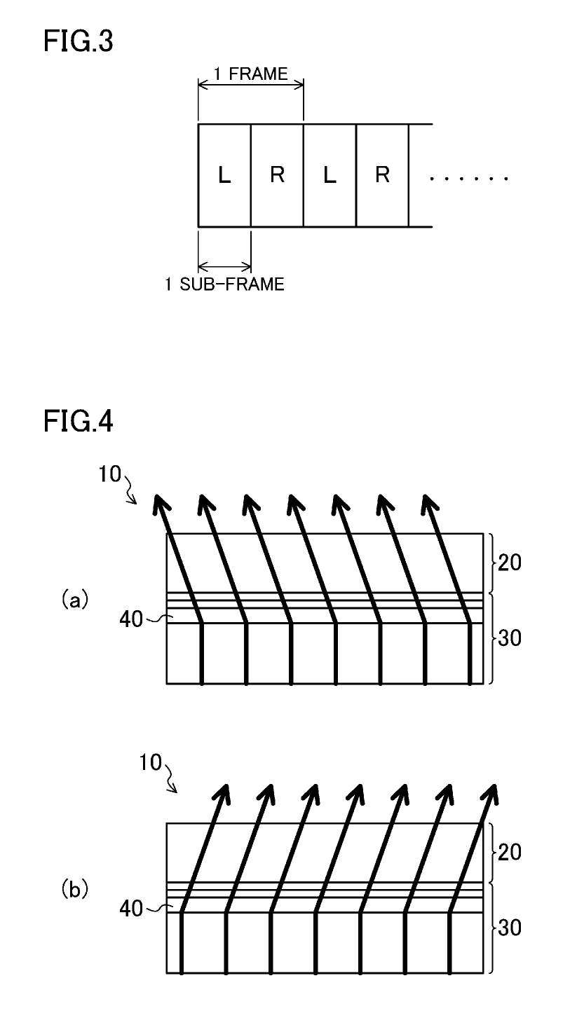

In the three-dimensional image display apparatus 10 having the configuration described above, the liquid crystal panel 20 displays a left-eye image L and a right-eye image R by switching the display from one to the other in one frame (e.g., 1/60 second for a refresh rate of 60 Hz). FIG. 3 is an explanatory view illustrating the order of images to be displayed by the liquid crystal panel 20, where the x axis represents the lapse of time. That is, each of the left-eye image L and the right-eye image R is displayed for the time of a half of one frame (e.g., 1/120 second for a refresh rate of 60 Hz). The time of a half of one frame is herein referred to as one sub-frame.

Simultaneously with the display of each image by the liquid crystal panel 20, a voltage is applied through the light path control element 40 in a direction orthogonal to the direction toward the liquid crystal panel 20 from the backlight unit 30. With the application of the voltage through the ferroelectric crystal layer 41, the ferroelectric crystals of the ferroelectric crystal layer 41 take on birefringence due to the Pockets effect, causing a change of the light path. When the left-eye image L is being displayed in the liquid crystal panel 20 during the first sub-frame, the light path control element 40 forms a light path directing to the left eye as shown in FIG. 4(a), whereby the left-eye image L reaches the left eye of the user. Subsequently, when the right-eye image R is displayed in the liquid crystal panel 20 with the change from the first sub-frame to the second sub-frame, the control of the voltage applied through the light path control element 40 is switched in synchronization with the switching of the display image from the left-eye image L to the right-eye image R. Thus, the light path control element 40 forms a light path directing to the right eye as shown in FIG. 4(b), whereby the right-eye image R reaches the right eye of the user.

As described above, in synchronization with the change from the first sub-frame to the second sub-frame in one frame, the control is switched from the state where the left-eye image L is shown to the left eye of the user to the state where the right-eye image R is shown to the right eye of the user. When the frame is shifted to the first sub-frame of the next frame, the control is switched again to the state where the left-eye image L is shown to the left eye of the user. In this way, by repeating this switching operation at high speed, the user can recognize three-dimensional image display.

The three-dimensional image display apparatus 10 can also display two-dimensional images by turning off the control by the light path control element 40 to stop refraction of the light path. Using this three-dimensional image display apparatus 10, two-dimensional display can be performed with no degradation in resolution because there is no such a device that controls the light path at all times, like the lenticular lens, and with excellent brightness because light does not pass through a light path control device made of a plurality of layers, like the parallax barrier.

### Effect of First Embodiment

In the three-dimensional image display apparatus 10 described above, in which the path of light output from the backlight source 31 can be electrically controlled by the light path control element 40, the light path can be formed so that the left-eye image L reach the left eye and the right-eye image R reach the right eye without use of glasses. Therefore, three-dimensional image display can be performed by the time-sharing system without degrading the resolution and the display quality compared with those at the time of two-dimensional display.

In the three-dimensional image display apparatus 10, it is only necessary to display left-eye images L and right-eye images R alternately in the liquid crystal panel 20. Therefore, it is unnecessary to newly generate a mixture image of a left-eye image L and a right-eye image R, as in the method described in Patent Document 1, for example, and thus no extra load is imposed.

### Alteration of First Embodiment

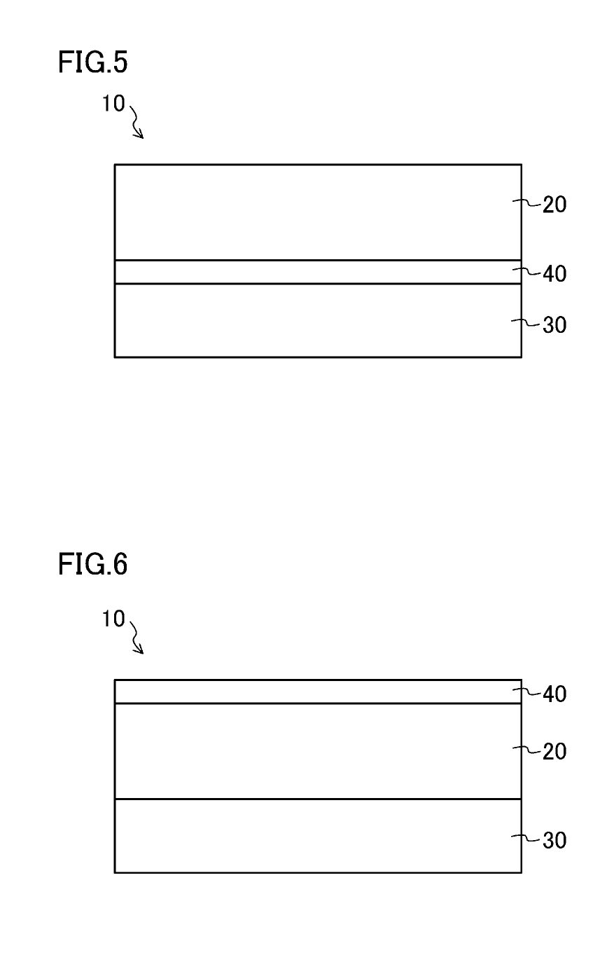

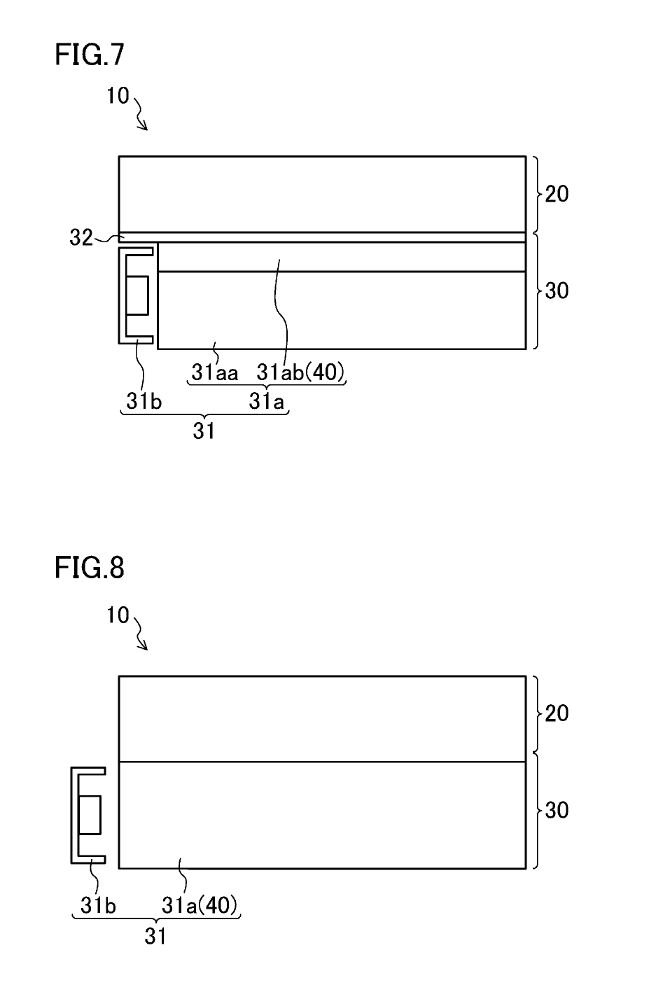

In the first embodiment, the light path control element 40 was described as being placed as one of the optical sheets 32 of the backlight unit 30. The light path control element 40 may otherwise be provided to be sandwiched between the liquid crystal panel 20 and the backlight unit 30 as shown as Alteration 1 in FIG. 5, or may be provided on the display side of the liquid crystal panel 20 as shown as Alteration 2 in FIG. 6, for example. Alternatively, as shown as Alteration 3 in FIG. 7, when the backlight source 31 of the backlight unit 30 is constituted by a light guide plate 31a and a light source 31b provided at an end of the light guide plate 31a, a light path control element 31ab (40) may be placed on the surface of a light guide plate body 31aa facing the liquid crystal panel 20, constituting the light guide plate 31a together with the light guide plate body 31aa. Otherwise, as shown as Alteration 4 in FIG. 8, when the backlight source 31 of the backlight unit 30 is constituted by a light guide plate 31a and a light source 31b provided at an end of the light guide plate 31a, the light guide plate 31a may be constituted by the light path control element 40. In this case, the light path is controlled so that light having entered the light guide plate 31a (light path control element 40) be diffused uniformly inside the light guide plate 31a and output from the side thereof facing the liquid crystal panel 20, and that, during display of a left-eye image L in the liquid crystal panel 20, the left-eye image L reach the left eye and, during display of a right-eye image R in the liquid crystal panel 20, the right-eye image R reach the right eye.

### Second Embodiment

### (Three-Dimensional Image Display Apparatus)

A three-dimensional image display apparatus 10 of the second embodiment will be described hereinafter. Note that like components having the same names as those in the first embodiment are denoted by the same reference characters.

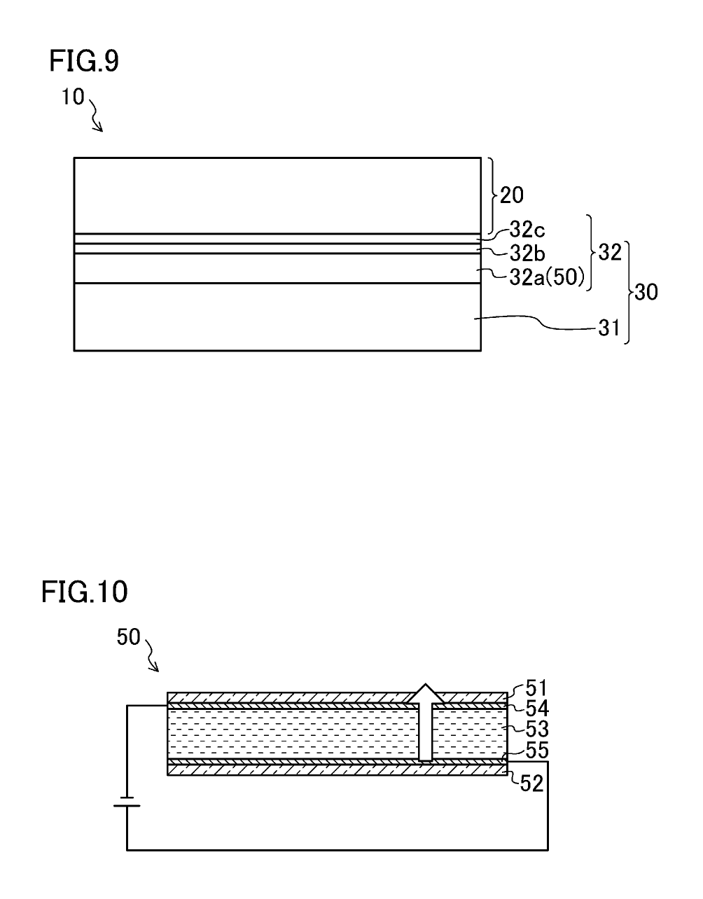

As shown in FIG. 9, the three-dimensional image display apparatus 10 includes a liquid crystal panel 20 and a backlight unit 30 provided on the side of the liquid crystal panel 20 opposite to the display side thereof. As in the first embodiment, a light path control element 50 (32a) is provided as one of optical sheets 32 of the backlight unit 30. Since the three-dimensional image display apparatus 10 of this embodiment has the same configuration as that of the first embodiment except for the light path control element 50, only the light path control element 50 will be described hereinafter.

As shown in FIG. 10, the light path control element 50 is a switching device having two transparent substrates 51 and 52 placed to face each other with a nematic liquid crystal layer 53 containing nematic liquid crystal interposed therebetween. The transparent substrates 51 and 52 may be a glass substrate or a transparent resin sheet. Transparent electrodes 54 and 55 (e.g., ITO electrodes) are respectively formed on the entire surfaces of the two transparent substrates 51 and 52 facing each other, to allow a voltage to be applied in a direction (direction of the arrow in FIG. 10) parallel to the direction toward the liquid crystal panel 20 from the backlight unit 30.

The light path control element 50 may be produced by a liquid crystal injection method where a nematic liquid crystal material is injected into the space between the two transparent substrates bonded together with a seal material, or by a liquid crystal drop method where a nematic liquid crystal material is dropped onto one transparent substrate 51 and then the resultant substrate is bonded with the other transparent substrate 52.

In the three-dimensional image display apparatus 10 having the above configuration, as in the first embodiment, the liquid crystal panel 20 displays a left-eye image L and a right-eye image R by switching the display from one to the other in one frame (e.g., 1/60 second for a refresh rate of 60 Hz). That is, each of the left-eye image L and the right-eye image R is displayed for the time of a half of one frame (e.g., 1/120 second for a refresh rate of 60 Hz).

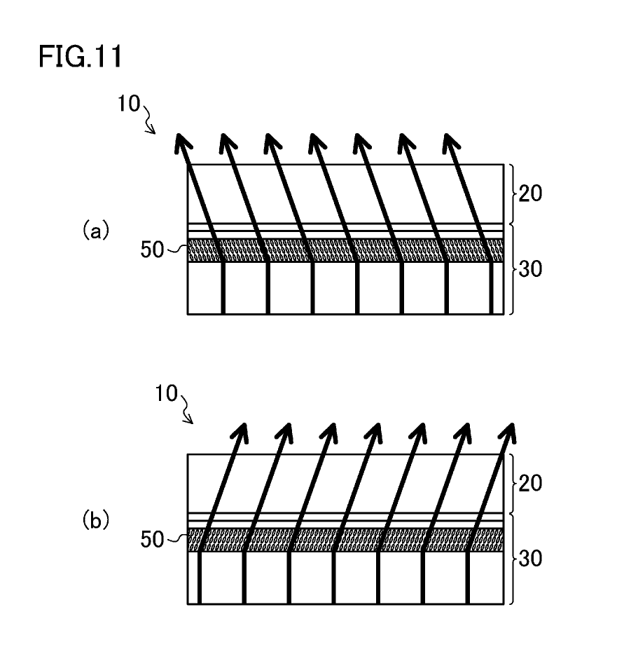

Simultaneously with the display of each image by the liquid crystal panel 20, a voltage is applied across the light path control element 50 in a direction parallel to the direction toward the liquid crystal panel 20 from the backlight unit 30. With the application of a voltage across the nematic liquid crystal layer 53, the light path is refracted due to the optical anisotropy of the nematic liquid crystal. When a left-eye image L is being displayed in the liquid crystal panel 20 during the first sub-frame, the light path control element 50 forms a light path directing to the left eye as shown in FIG. 11(a), whereby the left-eye image L reaches the left eye of the user. Subsequently, when a right-eye image R is displayed in the liquid crystal panel 20 with the change from the first sub-frame to the second sub-frame, the control of the voltage applied across the light path control element 50 is switched in synchronization with the switching of the display image from the left-eye image to the right-eye image. Thus, the light path control element 50 forms a light path directing to the right eye as shown in FIG. 11(b), whereby the right-eye image R reaches the right eye of the user.

As described above, in synchronization with the change from the first sub-frame to the second sub-frame in one frame, the control is switched from the state where the left-eye image L is shown to the left eye of the user to the state where the right-eye image R is shown to the right eye of the user. When the frame is shifted to the first sub-frame of the next frame, the control is switched again to the state where the left-eye image L is shown to the left eye of the user. In this way, by repeating this switching operation at high speed, the user can recognize three-dimensional image display.

The three-dimensional image display apparatus 10 can also display two-dimensional images by turning off the control by the light path control element 50 to stop refraction of the light path.

### Effect of Second Embodiment

In the three-dimensional image display apparatus 10 described above, in which the path of light output from the backlight source 31 can be electrically controlled by the light path control element 50, the light path can be formed so that the left-eye image L reach the left eye and the right-eye image R reach the right eye without use of glasses. Therefore, three-dimensional image display can be performed by the time-sharing system without degrading the resolution and the display quality compared with those at the time of two-dimensional display.

### Alteration of Second Embodiment

In the three-dimensional image display apparatus 10 of the second embodiment, as in the first embodiment, the light path control element 50 may be provided to be sandwiched between the liquid crystal panel 20 and the backlight unit 30, or may be provided on the display side of the liquid crystal panel 20. Otherwise, in the case of the edge light type where the backlight source 31 of the backlight unit 30 is constituted by a light guide plate and a light source provided at an end of the light guide plate, the light path control element 50 may be placed on the surface of a light guide plate body facing the liquid crystal panel 20, constituting the light guide plate together with the light guide plate body. Otherwise, in the case of the edge light type where the backlight source 31 of the backlight unit 30 is constituted by a light guide plate and a light source provided at an end of the light guide plate, the light guide plate may be constituted by the light path control element 50.

### INDUSTRIAL APPLICABILITY

The present disclosure is useful for three-dimensional image display apparatuses performing three-dimensional image display without use of glasses by the time-sharing system.

### DESCRIPTION OF REFERENCE CHARACTERS

L Left-Eye Image

R Right-Eye Image

10 Three-dimensional Image Display Apparatus

20 Liquid Crystal Panel

30 Backlight Unit

31 Backlight Source

32 Optical Sheet

40 (32a) Light Path Control Element (Switching Device)

41 Ferroelectric Crystal Layer

50 (32a) Light Path Control Element (Switching Device)

1. A three-dimensional image display apparatus, comprising:
a backlight unit including a backlight source; and
a liquid crystal panel provided on a display side of the backlight unit, configured to transmit light output from the backlight unit,
the apparatus performing three-dimensional image display by displaying left-eye images and right-eye images alternately to show the images to the left eye and right eye of the user, respectively,
wherein
a light path control element capable of electrically controlling the path of light output from the backlight source is provided,
during display of a left-eye image, a light path allowing the left-eye image to reach the left eye is formed by adjusting a voltage applied to the light path control element, and
in synchronization with switching of the display image from the left-eye image to a right-eye image, the control of the voltage applied to the light path control element is switched to form a light path allowing the right-eye image to reach the right eye.

2. The three-dimensional image display apparatus of claim 1, wherein
the light path control element is formed of a switching device where a voltage is applied in a direction orthogonal to a direction toward the liquid crystal panel from the backlight unit.

3. The three-dimensional image display apparatus of claim 2, wherein
the light path control element is formed of a ferroelectric crystal layer including ferroelectric crystals.

4. The three-dimensional image display apparatus of claim 1, wherein
the light path control element is formed of a switching device where a voltage is applied in a direction parallel to a direction toward the liquid crystal panel from the backlight unit.

5. The three-dimensional image display apparatus of claim 4, wherein
the light path control element is formed of a nematic liquid crystal layer including nematic liquid crystal.

6. The three-dimensional image display apparatus of claim 5, wherein
the backlight unit includes a plurality of optical sheets provided on the side of the backlight source closer to the liquid crystal panel, and
one of the plurality of optical sheets is the light path control element.

7. The three-dimensional image display apparatus of claim 5, wherein
the light path control element is provided between the backlight unit and the liquid crystal panel.

8. The three-dimensional image display apparatus of claim 5, wherein
the light path control element is provided on the display side of the liquid crystal panel.

9. The three-dimensional image display apparatus of claim 5, wherein
the backlight source is of an edge light type including a light guide plate and a light source provided at an end of the light guide plate, and
the light guide plate is constituted by a light guide plate body and the light path control element placed on the surface of the light guide plate body facing the liquid crystal panel.

10. The three-dimensional image display apparatus of claim 5, wherein
the backlight source is of an edge light type including a light guide plate and a light source provided at an end of the light guide plate, and
the light guide plate is constituted by the light path control element.
